(19) United States
(12) Patent Application Publication
(10) Pub. No.: US 2026/0333171 A1
(43) Pub. Date: Oct. 22, 2026

(54) TERMINAL DEVICE, INFORMATION PROCESSING SYSTEM, COMMUNICATION CONTROL METHOD, AND VEHICLE

(71) Applicant: TOYOTA JIDOSHA KABUSHIKI KAISHA, Toyota-shi (JP)

(72) Inventor: Kazuya OKADA, Tokyo (JP)

(73) Assignee: TOYOTA JIDOSHA KABUSHIKI KAISHA, Toyota-shi (JP)

(21) Appl. No.: 19/642,759

(22) Filed: Apr. 9, 2026

(30) Foreign Application Priority Data
Apr. 17, 2025 (JP) 2025-068271

(51) Int. Cl. H04W 36/30; H04L 45/00; H04L 45/021; H04W 4/40

(52) U.S. Cl. CPC H04W 36/304; H04L 45/021; H04L 45/22; H04W 4/40

(57) ABSTRACT

A terminal device controls switching of communication lines, and includes a processor. The processor is configured to measure a communication quality for each of a plurality of the communication lines including a main-line that is being used for communication and one or more sub-lines that are not being used for communication. The processor is configured to switch the communication line from the main-line to a predetermined sub-line of the one or more sub-lines, in a case where a determination that the communication quality measured for the main-line has become lower than the communication quality measured for the predetermined sub-line is made.

### CROSS-REFERENCE TO RELATED APPLICATION

This application claims priority to Japanese Patent Application No. 2025-068271 filed on Apr. 17, 2025. The disclosure of the above-identified application, including the specification, drawings, and claims, is incorporated by reference herein in its entirety.

### BACKGROUND

### TECHNICAL FIELD

The present disclosure relates to a terminal device, an information processing system, a communication control method, and a vehicle.

### DESCRIPTION OF RELATED ART

A communication technology in which a plurality of communication lines is used is known. For example, Japanese Unexamined Patent Application Publication No. 2022-072271 (JP 2022-072271 A) discloses a movement body including an information processing device that performs switching from a communication rate control based on a future communication throughput to a communication rate control based on band information in the case where at least one of the execution of handover and the switching of a communication band is detected.

### SUMMARY

However, there is room for improvement in the technology relevant to the line switching when a plurality of communication lines is used.

The present disclosure provides a terminal device, an information processing system, a communication control method, a non-transitory storage medium, and a vehicle that improve the technology relevant to the line switching when a plurality of communication lines is used.

A terminal device according to a first aspect of the present disclosure controls switching of communication lines, and includes a processor. The processor is configured to measure a communication quality for each of a plurality of the communication lines including a main-line that is being used for communication and one or more sub-lines that are not being used for communication. The processor is configured to switch the communication line from the main-line to a predetermined sub-line of the one or more sub-lines, in a case where a determination that the communication quality measured for the main-line has become lower than the communication quality measured for the predetermined sub-line is made.

In the terminal device according to the first aspect of the present disclosure, the main-line and the predetermined sub-line may be managed by different telecommunication carriers from each other.

In the terminal device according to the first aspect of the present disclosure, the communication quality may include a quality that influences a user feeling for an application that operates in the terminal device.

In the terminal device according to the first aspect of the present disclosure, the processor may be configured to alter a route for policy routing, and alter an NIC that is used for a destination IP address, to an NIC for the predetermined sub-line, in the switching of the communication line.

In the terminal device according to the first aspect of the present disclosure, the processor may be configured to update a route table by issuing an update instruction about a network guidance rule.

In the terminal device according to the first aspect of the present disclosure, the processor may be configured to rewrite the destination IP address and a source IP address by registering rewriting information in a map that manages addresses.

In the terminal device according to the first aspect of the present disclosure, the processor may be configured to send a reset signal to a session for an application that matches the destination IP address before the rewriting, the reset signal having a packet that includes a sequence number recorded in the map.

An information processing system according to a second aspect of the present disclosure may include: the terminal device according to the first aspect; a plurality of the communication lines configured to communicate with the terminal device; and a server configured to communicate with the terminal device through one of the communication lines.

A communication control method according to a third aspect of the present disclosure is a method for controlling switching of communication lines. The communication control method includes: measuring a communication quality for each of a plurality of the communication lines including a main-line that is being used for communication and one or more sub-lines that are not being used for communication; and switching the communication line from the main-line to a predetermined sub-line of the one or more sub-lines, in a case where a determination that the communication quality measured for the main-line has become lower than the communication quality measured for the predetermined sub-line is made.

In the communication control method according to the third aspect of the present disclosure, the main-line and the predetermined sub-line may be managed by different telecommunication carriers from each other.

In the communication control method according to the third aspect of the present disclosure, the communication quality may include a quality that influences a user feeling for an application that operates in the terminal device.

In the communication control method according to the third aspect of the present disclosure, the switching the communication line may include altering a route for policy routing, and altering an NIC that is used for a destination IP address, to an NIC for the predetermined sub-line.

In the communication control method according to the third aspect of the present disclosure, the switching the communication line may include updating a route table by issuing an update instruction about a network guidance rule.

In the communication control method according to the third aspect of the present disclosure, the switching the communication line may include rewriting the destination IP address and a source IP address by registering rewriting information in a map that manages addresses.

The communication control method according to the third aspect of the present disclosure may include sending a reset signal to a session for an application that matches the destination IP address before the rewriting, the reset signal having a packet that includes a sequence number recorded in the map.

A non-transitory storage medium according to a fourth aspect of the present disclosure stores instructions that are executable by one or more processors in a computer and that cause the one or more processors to perform functions. The one or more processors control switching of communication lines. The functions include: measuring a communication quality for each of a plurality of the communication lines including a main-line that is being used for communication and one or more sub-lines that are not being used for communication; and switching the communication line from the main-line to a predetermined sub-line of the one or more sub-lines, in a case where a determination that the communication quality measured for the main-line has become lower than the communication quality measured for the predetermined sub-line is made.

A vehicle according to a fifth aspect of the present disclosure controls switching of communication lines, and includes a processor. The processor is configured to measure a communication quality for each of a plurality of the communication lines including a main-line that is being used for communication and one or more sub-lines that are not being used for communication. The processor is configured to switch the communication line from the main-line to a predetermined sub-line of the one or more sub-lines, in a case where a determination that the communication quality measured for the main-line has become lower than the communication quality measured for the predetermined sub-line is made.

In the vehicle according to the fifth aspect of the present disclosure, the main-line and the predetermined sub-line may be managed by different telecommunication carriers from each other.

In the vehicle according to the fifth aspect of the present disclosure, the communication quality may include a quality that influences a user feeling for an application that operates in the vehicle.

In the vehicle according to the fifth aspect of the present disclosure, the processor may be configured to alter a route for policy routing, and alter an NIC that is used for a destination IP address, to an NIC for the predetermined sub-line, in the switching of the communication line.

The terminal device according to the first aspect of the present disclosure improves the technology relevant to the line switching when a plurality of communication lines is used.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a configuration diagram showing an example of the configuration of an information processing system including a terminal device according to an embodiment of the present disclosure;

FIG. 2 is a block diagram showing an example of the configuration of the information processing system in FIG. 1;

FIG. 3 is a schematic diagram for describing an example of the operation of the terminal device according to the embodiment of the present disclosure;

FIG. 4 is a schematic diagram for describing an example of the operation of the information processing system according to the embodiment of the present disclosure; and

FIG. 5 is a flowchart for describing an example of a communication control method that is executed by the terminal device in FIG. 2.

### DETAILED DESCRIPTION OF EMBODIMENTS

An embodiment of the present disclosure will be described below with reference to the accompanying drawings. The following description about a terminal device 10 is applied also to an information processing system 1 that includes the terminal device 10, a communication control method that is executed by the terminal device 10, a program that causes the terminal device 10 as a computer to execute the operation, and a vehicle that functions similarly to the terminal device 10, in the present disclosure.

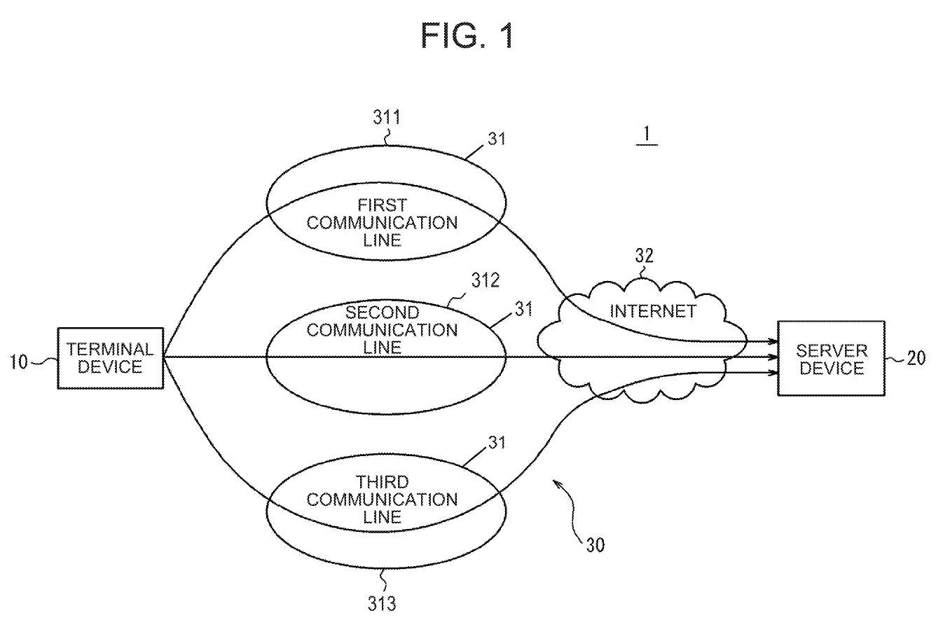

FIG. 1 is a configuration diagram showing an example of the configuration of the information processing system 1 including the terminal device 10 according to the embodiment of the present disclosure. The overview of the information processing system 1 including the terminal device 10 according to the embodiment of the present disclosure will be mainly described with reference to FIG. 1. The information processing system 1 includes a server device 20 in addition to the terminal device 10.

In FIG. 1, for simplified illustration of the figure, only one terminal device 10 is illustrated, but the number of terminal devices 10 included in the information processing system 1 may be two or more. Similarly, in FIG. 1, only one server device 20 is illustrated, but the number of server devices 20 included in the information processing system 1 may be two or more. Each of the terminal device 10 and the server device 20 is communicably connected with a network 30 including a plurality of communication lines 31, the internet 32, and the like. One device of the terminal device 10 and the server device 20 is connected so as to mutually communicate with the other device through the network 30. The network 30 is included in the information processing system 1.

The communication lines 31 included in the information processing system 1 are communicably connected with the terminal device 10. In FIG. 1, as an example, the communication lines 31 included in the network 30 include three communication lines: a first communication line 311, a second communication line 312, and a third communication line 313. For example, each of the first communication line 311, the second communication line 312, and the third communication line 313 includes an arbitrary communication network such as a mobile communication network, a wireless communication network, a wire communication network, or a satellite communication network.

For example, the mobile communication network includes a communication network based on a system such as Long Term Evolution (LTE), 4th Generation (4G), or 5th Generation (5G). For example, the wireless communication network includes a wireless local area network (LAN) that is constructed by a wireless communication system such as WiFi (R). For example, the wire communication network includes a wire LAN that is constructed by a wire communication system such as Ethernet. For example, the satellite communication network includes a communication network based on a low-earth-orbit (LEO) satellite communication system such as Starlink (R), a stationary satellite communication system such as Intelsat (R), or the like.

As for the communication lines 31, all thereof may be managed by different telecommunication carriers from each other, or some thereof may be managed by an identical telecommunication carrier. For example, the first communication line 311 may be managed by Company A that is a telecommunication carrier, the second communication line 312 may be managed by Company B that is a telecommunication carrier, and the third communication line 313 may be managed by Company C that is a telecommunication carrier.

Examples of the terminal device 10 include arbitrary general-purpose electronic apparatuses such as a personal computer (PC), a tablet PC, a smartphone, or a wearable device including a smartwatch. Without being limited thereto, the terminal device 10 may include in-vehicle apparatuses that are equipped in a vehicle, and may include other electronic apparatuses that are dedicated for the information processing system 1. For example, based on an input operation accepted from a user, the terminal device 10 accesses the server device 20 through the network 30, and outputs, to the user, a delivery content such as an image including a video. For example, the terminal device 10 includes an electronic apparatus that is used by a user who wants to receive a content such as a delivery content, from the information processing system 1.

For example, the server device 20 includes one device or a plurality of devices that can communicate with each other. The server device 20 may include an electronic apparatus that is dedicated for the information processing system 1, or may include an electronic apparatus that is not dedicated for the information processing system 1. The server device 20 accepts the access from the terminal device 10 through the network 30, and then provides a content such as a delivery content, to the terminal device 10, as information. For example, for realizing a content delivery system, the server device 20 is used in cooperation with the terminal device 10 and the network 30. The server device 20 is communicably connected with the terminal device 10 through one of the communication lines 31.

As the overview of the embodiment, the terminal device 10 controls switching of the communication line 31. The terminal device 10 measures a communication quality for each of the communication lines 31 including a main-line that is being used for communication and one or more sub-lines that are not being used for communication. The main-line and a predetermined sub-line are managed by different telecommunication carriers from each other. In this respect, the present disclosure is essentially different from handover, in which a base station is switched on one communication line that is managed by one telecommunication carrier. In the present disclosure, examples of the "main-line" include a line of the communication lines 31 that is being currently used for communication. Examples of the "sub-line" include lines of the communication lines 31 that are other than the main-line.

For example, in the information processing system 1, in a case where the terminal device 10 is communicating with the server device 20 using the first communication line 311 of the communication lines 31, the first communication line 311 is the main-line. Each of the second communication line 312 and the third communication line 313 of the communication lines 31 that are other than the first communication line 311 is the sub-line.

Then, after the switching of the communication line 31, in a case where the terminal device 10 is communicating with the server device 20 using the second communication line 312 of the communication lines 31, the second communication line 312 is the main-line. Each of the first communication line 311 and the third communication line 313 of the communication lines 31 that are other than the second communication line 312 is the sub-line.

In the present disclosure, for example, the "communication quality" includes a quality that influences a user feeling for an application that operates in the terminal device 10. In this respect, the communication quality is different from the communication quality in the handover, in which the process is executed on a first layer or a second layer in an OSI reference model, for example. For example, the communication quality includes qualities related to higher layers of stack layers, as exemplified by communication delay (latency), communication speed (throughput), jitter, packet loss, or band. For example, the higher layers may include third or higher layers in the OSI reference model, or may include higher layers than a "network interface layer (data link layer)" at the lowermost layer in the layer structure of a TCP/IP stack.

The terminal device 10 switches the communication line 31 from the main-line to the predetermined sub-line, when the determination that the communication quality measured for the main-line has become lower than the communication quality measured for the sub-line is made. For example, in the case where the communication with the server device 20 is being currently performed using the first communication line 311 as the main-line, when it is determined that the communication quality measured for the first communication line 311 has become lower than, for example, the communication quality measured for the second communication line 312, the terminal device 10 switches the communication line 31 from the first communication line 311 to the second communication line 312. In the present disclosure, "the communication quality becoming low" includes, for example, values of the above parameters included in the communication quality changing so as to degrade.

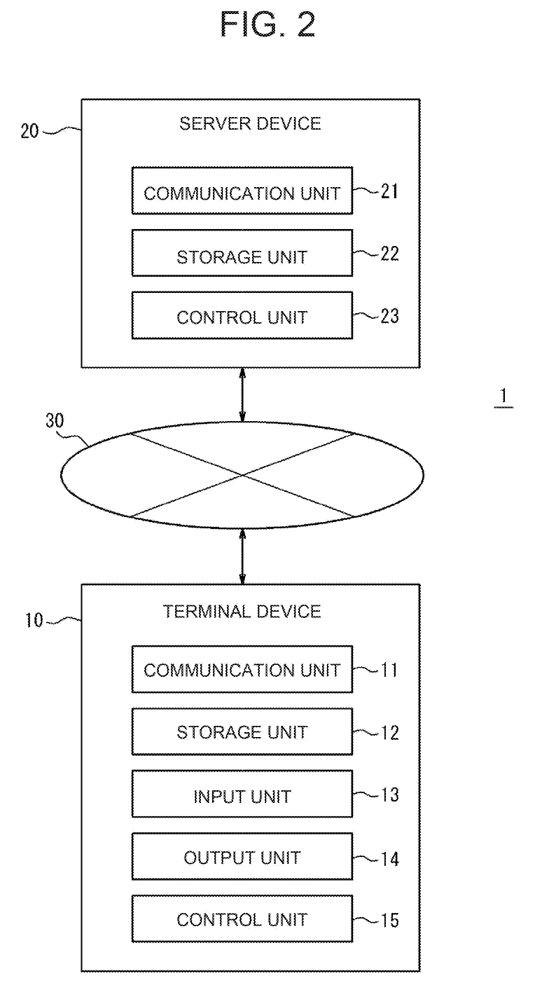

FIG. 2 is a block diagram showing an example of the configuration of the information processing system 1 in FIG. 1. An example of each configuration of the terminal device 10 and the server device 20 will be mainly described with reference to FIG. 2. The terminal device 10 includes a communication unit 11, a storage unit 12, an input unit 13, an output unit 14, and a control unit 15.

The communication unit 11 includes one or more communication interfaces that are connected to the network 30. The communication interface complies with a mobile communication standard such as LTE, 4G, or 5G, a wireless LAN standard, a wire LAN standard, or a satellite communication standard, but without being limited thereto, may comply with an arbitrary communication standard. For example, the communication interface may comply with a short-range wireless communication standard. In the embodiment, the terminal device 10 is communicably connected to the network 30 through the communication unit 11. The communication unit 11 sends and receives a variety of information through the network 30.

The storage unit 12 includes one or more memories. In the present disclosure, the "memory" includes a semiconductor memory, a magnetic memory, or an optical memory, for example, but is not limited thereto. Each memory included in the storage unit 12 may function as a main storage device, an auxiliary storage device, or a cache memory, for example. The storage unit 12 stores information necessary for realizing the operation of the terminal device 10. For example, the storage unit 12 may store a system program, an application program, or built-in software. The storage unit 12 stores information obtained by the operation of the terminal device 10. The information stored in the storage unit 12 may be updatable by information acquired from the network 30 through the communication unit 11, for example.

The input unit 13 includes one or more input interfaces that detect user's input and acquire input information based on user's operation. The input interface includes a physical key, a capacitance key, a pointing device such as a mouse, a touch screen provided integrally with a display of the output unit 14, an imaging module such as a camera, or a microphone that accepts voice input. The input unit 13 is not limited thereto, and may include another arbitrary input interface. The input unit 13 may be connected to the terminal device 10 as an external input apparatus, instead of being included in the terminal device 10. As the connection system, for example, an arbitrary system such as Universal Serial Bus (USB), High-Definition Multimedia Interface (HDMI (R)), or Bluetooth (R) can be used.

The output unit 14 includes one or more output interfaces that output information to the user that uses the terminal device 10. The output interface includes a display that visually outputs information as images, a speaker that aurally outputs information as sound, a vibrator that tactually outputs information as vibration, or the like. In the present disclosure, examples of the "display" include a liquid crystal display (LCD) or an organic electroluminescent (EL) display. The output unit 14 may be connected to the terminal device 10 as an external output apparatus, instead of being included in the terminal device 10. As the connection system, an arbitrary system such as USB, HDMI (R), or Bluetooth (R) can be used.

The control unit 15 includes one or more processors, one or more programmable circuits, one or more dedicated circuits, or combinations of them. In the present disclosure, the "processor" is a general-purpose processor such as a central processing unit (CPU) or a graphic processing unit (GPU), or a dedicated processor for a particular process, for example, but is not limited thereto. The "programmable circuit" is a field-programmable gate array (FPGA), for example, but is not limited thereto. The "dedicated circuit" is an application specific integrated circuit (ASIC), for example, but is not limited thereto. The control unit 15 is communicably connected with each constituent unit that constitutes the terminal device 10, and controls the whole operation of the terminal device 10.

Functions of the terminal device 10 are realized by executing a program according to the embodiment by a processor corresponding to the control unit 15. That is, functions of the terminal device 10 are realized by software. The program causes a computer to function as the terminal device 10 by causing the computer to execute the operation of the terminal device 10. That is, the computer functions as the terminal device 10 by executing the operation of the terminal device 10 in accordance with the program.

The program in the embodiment can be recorded in a computer-readable recording medium. The computer-readable recording medium includes a non-transitory computer-readable medium, and is a magnetic recording device, an optical disc, a magneto-optical recording medium, or a semiconductor memory, for example. For example, the distribution of the program is performed by sales, transfer, or leasing of a portable recording medium in which the program is recorded, as exemplified by a digital versatile disc (DVD) or a compact disc read only memory (CD-ROM). The distribution of the program may be performed by storing the program in a storage of an external server and sending the program from the external server to another computer. The program may be provided as a program product.

Some or all of the functions of the terminal device 10 may be realized by a dedicated circuit corresponding to the control unit 15. That is, some or all of the functions of the terminal device 10 may be realized by hardware.

Next, an example of the configuration of the server device 20 will be mainly described. The server device 20 includes a communication unit 21, a storage unit 22, and a control unit 23.

The communication unit 21 includes one or more communication interfaces that are connected to the network 30. The communication interface complies with a mobile communication standard such as LTE, 4G, or 5G, a wireless LAN standard, a wire LAN standard, or a satellite communication standard, but without being limited thereto, may comply with an arbitrary communication standard. For example, the communication interface may comply with a short-range wireless communication standard. In the embodiment, the server device 20 is communicably connected to the network 30 through the communication unit 21. The communication unit 21 sends and receives a variety of information through the network 30.

The storage unit 22 includes one or more memories. Each memory included in the storage unit 22 may function as a main storage device, an auxiliary storage device, or a cache memory, for example. The storage unit 22 stores information necessary for realizing the operation of the server device 20. For example, the storage unit 22 may store a system program, an application program, or built-in software. The storage unit 22 stores information obtained by the operation of the server device 20. The information stored in the storage unit 22 may be updatable by information acquired from the network 30 through the communication unit 21, for example.

The control unit 23 includes one or more processors, one or more programmable circuits, one or more dedicated circuits, or combinations of them. The control unit 23 is communicably connected with each constituent unit that constitutes the server device 20, and controls the whole operation of the server device 20.

Functions of the server device 20 are realized by executing a program according to the embodiment by a processor corresponding to the control unit 23. That is, functions of the server device 20 are realized by software. The program causes a computer to function as the server device 20 by causing the computer to execute the operation of the server device 20. That is, the computer functions as the server device 20 by executing the operation of the server device 20 in accordance with the program.

Some or all of the functions of the server device 20 may be realized by a dedicated circuit corresponding to the control unit 23. That is, some or all of the functions of the server device 20 may be realized by hardware.

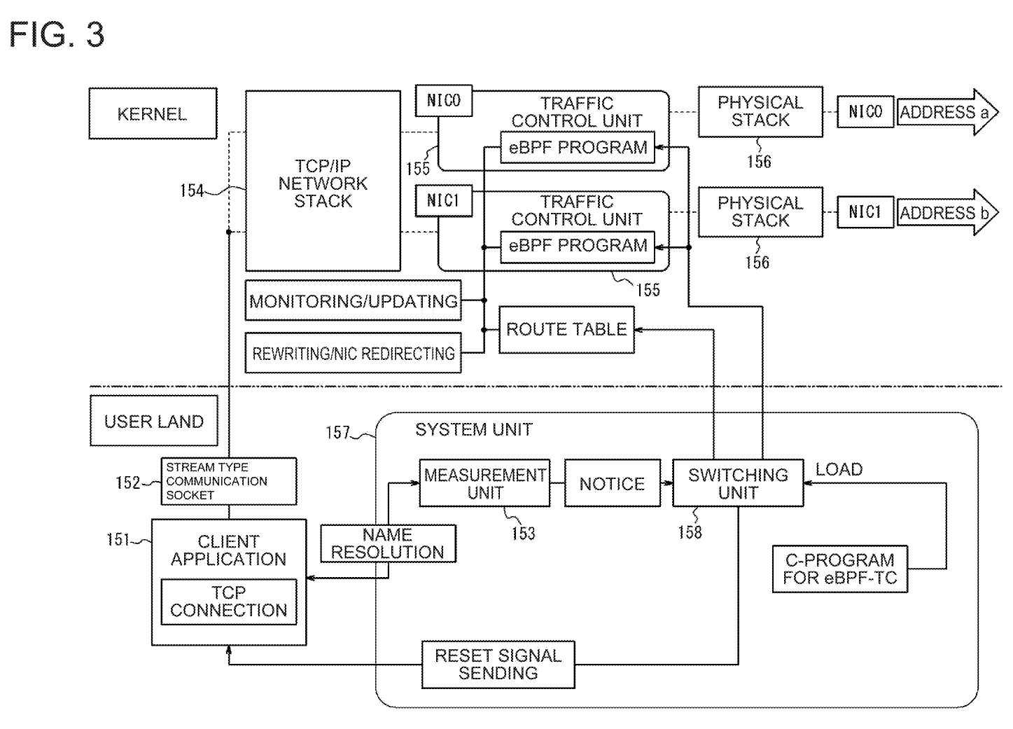

FIG. 3 is a schematic diagram for describing an example of the operation of the terminal device 10 according to the embodiment of the present disclosure. FIG. 3 is a schematic diagram conceptually showing blocks as functional units for functions that are realized by the control unit 15 of the terminal device 10, for each of a user land and a kernel. FIG. 3 is slightly different in configuration from FIG. 1, in that it is assumed that the terminal device 10 is communicably connected to two communication lines 31. An example of the operation that is realized by the control unit 15 of the terminal device 10 in FIG. 2 will be described in detail, with reference to FIG. 3.

For example, the control unit 15 of the terminal device 10 causes a client application 151 to operate in the user land, to start a TCP connection to a destination. For example, the client application 151 has a function to establish a communication connection to the server device 20, using a stream type communication socket 152.

Before a communication request, the client application 151 issues a name resolution request, using a domain name for identifying a connection destination, and acquires a destination IP address corresponding to the domain name, through predetermined name resolution means. For example, a name resolution process is executed using a measurement unit 153 that has also a domain name system (DNS) resolution function, and is realized by a local cache in the interior of the terminal device 10, a DNS forwarder, a DNS server in the exterior, or the like.

For example, a TCP/IP network stack 154 operates on the kernel side. The TCP/IP network stack 154 is a communication protocol processing mechanism for sequentially processing sending data from the client application 151 through a transport layer, an internet layer, and a data link layer, and sending the data through a network interface card (NIC).

The control unit 15, in a traffic control unit 155, forcibly designates a communication route using policy routing, such that communication is performed using a line (NIC0 or NIC1) corresponding to the destination IP address. The control unit 15 causes an extended Berkeley Packet Filter (eBPF) map program for the NIC to operate in the kernel, and stores sequence information for TCP in the storage unit 12. In the present disclosure, for example, the "sequence information" includes "source IP address / source port / destination IP address / destination port" as "key", and includes "next sequence number" as "value".

A sending packet, after a protocol process in the TCP/IP network stack 154 in the kernel, is sent from the NIC0 or the NIC1 to an external network via a physical stack 156. The sending packet includes the source IP address and the destination IP address, which is shown as an "ADDRESS a" or "ADDRESS b" in FIG. 3. The destination IP address is information that is used for communication route decision or traffic control in the traffic control unit 155.

In the example shown in FIG. 3, a principal functional unit for realizing the control of the switching of the communication line 31 by the control unit 15 of the terminal device 10 is disposed on the user land side, as a system unit 157. The system unit 157 includes the measurement unit 153 and a switching unit 158. For example, the control unit 15 causes the measurement unit 153 to operate in the user land, and measures a communication quality for each of the communication lines 31 including a main-line that is being used for communication and one or more sub-lines that are not being used for communication.

For example, the measurement unit 153 causes a communication quality measurement program to operate in the user land, and periodically measures the communication quality such as communication delay (latency) from each of the communication lines 31 to the destination IP address, in accordance with Internet Control Message Protocol (ICMP). The measurement unit 153 provides notice of a measurement result about the communication quality related to network switching, to the switching unit 158.

The switching unit 158 executes a process of loading a C-program for eBPF that operates in the traffic control unit 155. The switching unit 158 performs processing such that the C-program for eBPF that is written in the user land can be read by the kernel space and can be used for a traffic control process in the traffic control unit 155, and the other processes. Thereby, the switching unit 158 allows the eBPF program to be attached to the traffic control unit 155.

For example, the control unit 15 causes the switching unit 158 to operate in the user land, and determines whether the communication quality measured for the main-line has become lower than the communication quality measured for a predetermined sub-line, based on the measurement result about the communication quality acquired from the measurement unit 153. When it is determined that the communication quality measured for the main-line has become lower than the communication quality measured for the predetermined sub-line, the switching unit 158 switches the communication line 31 from the main-line to the predetermined sub-line.

For example, in the switching of the communication line 31, the switching unit 158 that functions as the control unit 15 alters a route for policy routing in the traffic control unit 155, and alters the NIC that is used for the destination IP address, to an NIC for the predetermined sub-line. At this time, for example, the switching unit 158 updates a route table by issuing an update instruction about a network guidance rule from the user land side to the kernel side. For example, the route table is stored in the storage unit 12.

In addition, the control unit 15 rewrites the destination IP address and the source IP address by registering rewriting information in a map that manages addresses. For example, the switching unit 158 issues an instruction from the user land side to the kernel side, to register rewriting information about addresses in an eBPF map. In the present disclosure, for example, the "rewriting information" includes "destination IP address before rewriting" as "key", and includes "destination IP address after rewriting / source IP address after rewriting" as "value".

The eBPF program attached through the traffic control unit 155 has a function to monitor or update a TCP traffic at the time of the sending of the TCP traffic. The eBPF program realizes a dynamic switching of the communication route for a packet determined as a network guidance target, by executing a rewriting process for the destination IP address and the source IP address on an IP layer and redirecting the NIC for the destination to the predetermined communication line 31.

The control unit 15 sends a reset signal having a packet that includes a sequence number recorded in the map, to a session for an application that matches the destination IP address before rewriting. For example, the switching unit 158 sends the reset signal having the packet that includes the sequence number recorded in the eBPF map, to the client application 151, as a reset signal at the time of network switching. The switching unit 158, in the user land, sends the reset signal to a TCP session for the client application 151 that matches the destination IP address before the rewriting. Thus, the switching unit 158 provides notice of which packet has been reset, to the client application 151.

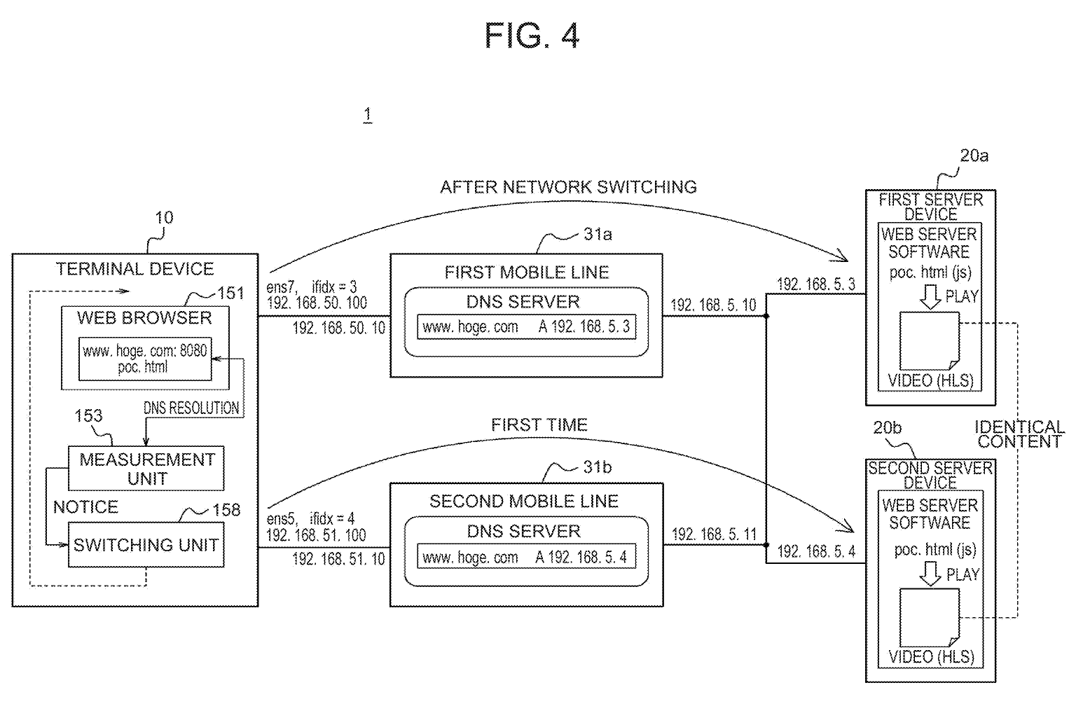

FIG. 4 is a schematic diagram for describing an example of the operation of the information processing system 1 according to the embodiment of the present disclosure. In FIG. 4, only one terminal device 10 is shown similarly to FIG. 1, but a different example from FIG. 1 is shown in that the information processing system 1 includes two communication lines 31 and two server devices 20.

In the example shown in FIG. 4, as the two communication lines 31, the information processing system 1 includes a first mobile line 31a and a second mobile line 31b. For example, the terminal device 10 is communicably connected with a first server device 20a through the first mobile line 31a. For example, the terminal device 10 is communicably connected with a second server device 20b through the second mobile line 31b.

For example, the terminal device 10 includes a plurality of NICs. For example, the terminal device 10 includes an NIC having identification information of ens7 (ifindex=3) that corresponds to the first mobile line 31a. The terminal device 10 includes an NIC having identification information of ens5 (ifindex=4) that corresponds to the second mobile line 31b. The terminal device 10 is communicably connected to the first server device 20a or the second server device 20b using one communication line 31, through, for example, the internet 32 also.

For example, the terminal device 10 accepts user's input operation with use of the input unit 13, and causes the client application 151, which includes a web browser, a video distribution application, or the like, to operate. When the terminal device 10 tries to access a site designated by a domain name "www.hoge.com" using the client application 151, the name resolution means in the measurement unit 153 operates and makes an inquiry to a DNS server.

The terminal device 10 executes a first-time communication by the NIC having the identification information of ens5 (ifindex=4), using the second mobile line 31b. To the NIC, for example, "192.168.51.100" is assigned as the source IP address. To the NIC, for example, "192.168.51.10" is set as a physical local IP address. Both of them belong to a network segment corresponding to the second mobile line 31b, and the sending packet is sent to the internet 32 side via the second mobile line 31b.

The DNS inquiry by the name resolution means is also performed via the second mobile line 31b. The IP address of the DNS server to which the connection is performed at this time is "192.168.5.11", for example. An IP address "192.168.5.4" corresponding to the domain name "www.hoge.com" is returned as a response from the DNS server. Thereby, the client application 151 starts a TCP connection in which the destination is "192.168.5.4", using the source IP address "192.168.51.100".

At this time, the terminal device 10 selects ens5 (ifindex=4) as a sending interface, by an initial route selection based on the policy routing in the traffic control unit 155, and sends the packet to the second server device 20b having the destination IP address "192.168.5.4". The second server device 20b provides "poc.html(js)" based on HTTP, for example, and furthermore performs video distribution based on HLS, for example. Examples of web server software that is used in the second server device 20b include nginx (R).

During the communication with use of the second mobile line 31b, the terminal device 10 periodically monitors the communication quality by the measurement unit 153. When it is determined in the switching unit 158 that the communication quality has become low, for example, because of the increase in communication delay, the terminal device 10 executes the network switching by the switching unit 158. Thereby, the terminal device 10 starts the guidance to the communication with use of the NIC having the identification information of ens7 (ifindex=3).

The terminal device 10 executes a communication after the network switching by the NIC having the identification information of ens7 (ifindex=3), using the first mobile line 31a. To the NIC, for example, "192.168.50.100" is assigned as the source IP address. To the NIC, for example, "192.168.50.10" is set as a physical local IP address. Both of them belong to a network segment corresponding to the first mobile line 31a, and the sending packet is sent to the internet 32 side via the first mobile line 31a.

The DNS inquiry by the name resolution means is also performed via the first mobile line 31a. The IP address of the DNS server to which the connection is performed at this time is "192.168.5.10", for example. An IP address "192.168.5.3" corresponding to the domain name "www.hoge.com" is returned as a response from the DNS server. Thereby, the client application 151 starts a TCP connection in which the destination is "192.168.5.3", using the source IP address "192.168.50.100".

At this time, the terminal device 10 selects ens7 (ifindex=3) as a sending interface, by a route selection after the network guidance based on the policy routing in the traffic control unit 155, and sends the packet to the first server device 20a having the destination IP address "192.168.5.3". The first server device 20a provides "poc.html(js)" based on HTTP, for example, and furthermore performs video distribution based on HLS, for example. Examples of web server software that is used in the first server device 20a include nginx (R).

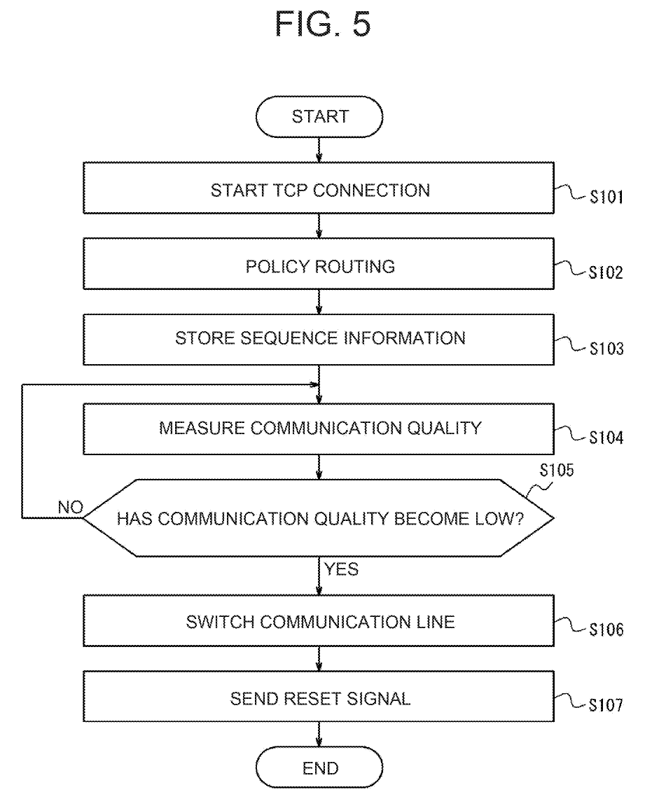

FIG. 5 is a flowchart for describing an example of a communication control method that is executed by the terminal device 10 in FIG. 2. An example of the communication control method that is executed by the terminal device 10 according to the embodiment will be mainly described with reference to FIG. 5. The flowchart in FIG. 5 shows an exemplary flow of a process that is executed by the control unit 15 of the terminal device 10.

In step S101, the control unit 15 of the terminal device 10 causes a client application 151 to operate, to start the TCP connection to the destination.

In step S102, the control unit 15 of the terminal device 10, in the traffic control unit 155, forcibly designates the communication route using the policy routing, such that communication is performed using a line corresponding to the destination IP address.

In step S103, the control unit 15 of the terminal device 10 causes the eBPF map program for the NIC to operate, and stores the sequence information for TCP in the storage unit 12.

In step S104, the control unit 15 of the terminal device 10 causes the measurement unit 153 to operate, and measures a communication quality for each of the communication lines 31 including the main-line that is being used for communication and the one or more sub-lines that are not being used for communication.

In step S105, the control unit 15 of the terminal device 10 causes the switching unit 158 to operate, and determines whether the communication quality measured for the main-line has become lower than the communication quality measured for the predetermined sub-line, based on the measurement result about the communication quality acquired from the measurement unit 153. When it is determined that the communication quality has become low, the control unit 15 executes a process in step S106. When it is determined that the communication quality has not become low, the control unit 15 executes the processes from step S104 again.

When it is determined in step S105 that the communication quality has become low, the control unit 15 of the terminal device 10 switches the communication line 31 from the main-line to the predetermined sub-line in step S106.

In step S107, the control unit 15 of the terminal device 10 sends the reset signal having the packet that includes the sequence number recorded in the eBPF map, to the TCP session for the client application 151 that matches the destination IP address before the rewriting.

After the network switching, the control unit 15 of the terminal device 10 executes communication using the predetermined sub-line as a main-line. The control unit 15 repeats the processes from step S101 to step S107, for the communication based on the new main-line, until the communication by the terminal device 10 is finished.

The above-described embodiment improves the technology relevant to the line switching when a plurality of communication lines 31 is used. For example, in a line-number multiplication in which a plurality of communication lines 31 is used for enhancing the reliability of the communication of an ordinary electronic apparatus, a connected car, or the like, the terminal device 10 can realize the dynamic line switching for TCP communication such that the process is completed on the client side. Accordingly, for example, the terminal device 10 only needs to use a socket API in the client application 151, and therefore, it is unnecessary to modify an existing application in the terminal device 10.

Unlike technologies such as handover, the terminal device 10 completes all processes including the measurement of the communication quality, the determination of deterioration of the communication quality, and the switching of the communication line 31, on the terminal device 10 side. In this respect, there is a great difference from the handover, in which basically, the measurement of electric wave intensity and a process of outputting the measurement result to the base station side are performed on the terminal device side and a process of deciding the switching of the base station is performed on the base station side.

The main-line and the predetermined sub-line are managed by different telecommunication carriers from each other. Thereby, unlike the handover, which is a technology to be used only in a communication line that is managed by one telecommunication carrier, the terminal device 10 can perform switching from one line to another line among a plurality of communication lines 31 that is managed by different telecommunication carriers from each other. In the line-number multiplication in which a plurality of communication lines 31 is used, the terminal device 10 can realize the dynamic line switching for TCP communication between different telecommunication carriers from each other such that the process is completed on the client side.

The communication quality includes the quality that influences the user feeling for the application that operates in the terminal device 10. Thereby, the terminal device 10 switches the communication line 31 depending on the deterioration in such a communication quality in the main-line, and therefore, it is possible to maintain a high-quality application operation, without impairing the feeling quality of the user that uses applications such as the client application 151 on the terminal device 10.

In the switching of the communication line 31, the terminal device 10 alters the route for the policy routing, and alters the NIC that is used for the destination IP address, to the NIC for the predetermined sub-line. Thereby, the terminal device 10 can more properly perform the switching of the communication line 31.

In the switching of the communication line 31, the terminal device 10 updates the route table by issuing the update instruction about the network guidance rule. Thereby, the terminal device 10 can more properly perform the switching of the communication line 31.

The terminal device 10 rewrites the destination IP address and the source IP address by registering the rewriting information in the map that manages addresses. Thereby, the terminal device 10 can more properly perform the switching of the communication line 31.

The terminal device 10 sends the reset signal having the packet that includes the sequence number recorded in the map, to the session for the application that matches the destination IP address before the rewriting. Thereby, the terminal device 10 can quickly realize TCP switching.

The present disclosure has been described based on the drawings and the embodiment. Note that a person skilled in the art can perform various alterations and modifications based on the present disclosure. Accordingly, it is noted that the alterations and the modifications are included in the scope of the present disclosure. For example, functions and others included in constituents, steps, or others can be reallocated such that there is no logical inconsistency, and a plurality of constituents, steps, or others can be combined to one, or can be divided.

For example, it is allowable to adopt a configuration in which a general-purpose electronic apparatus such as a smartphone or a computer functions as the terminal device 10 according to the above embodiment. Specifically, a program in which processing contents for realizing functions of the terminal device 10 according to the embodiment, and the like are written is stored in a memory of the electronic apparatus, and the program is read and executed by a processor of the electronic apparatus. Accordingly, the present disclosure can be realized as a program that is executable by a processor.

Alternatively, the present disclosure can be realized as a non-transitory computer-readable medium storing a program that is executable by one or more processors for executing functions of the terminal device 10 according to the embodiment, and the like. It should be understood that the scope of the present disclosure includes also the program and the non-transitory computer-readable medium.

For example, a processing operation that is executed in the terminal device 10 in the above embodiment may be executed in a vehicle. On this occasion, the vehicle may execute the above processing operation that is executed in the terminal device 10, by equipping with the terminal device 10 according to the embodiment as an in-vehicle apparatus, or may execute the above processing operation using another electronic apparatus that is dedicated for the vehicle.

In the above embodiment, it has been described that the main-line and the predetermined sub-line are managed by different telecommunication carriers from each other, but the present disclosure is not limited thereto. The main-line and the predetermined sub-line may be managed by an identical telecommunication carrier.

In the above embodiment, it has been described that the communication quality includes the quality that influences the user feeling for the application that operates in the terminal device 10, but the present disclosure is not limited thereto. The communication quality may include a quality that does not influence the user feeling for the application that operates in the terminal device 10.

In the above embodiment, it has been described that the terminal device 10 alters the route for the policy routing, and alters the NIC that is used for the destination IP address, to the NIC for the predetermined sub-line, in the switching of the communication line 31, but the present disclosure is not limited thereto. In the switching of the communication line 31, the terminal device 10 may alter the NIC that is used for the destination IP address, to the NIC for the predetermined sub-line, based on another method different from the policy routing.

In the above embodiment, it has been described that the terminal device 10 updates the route table by issuing the update instruction about the network guidance rule, but the present disclosure is not limited thereto. The terminal device 10 may update the network guidance rule based on a method different from the route table.

In the above embodiment, it has been described that the terminal device 10 rewrites the destination IP address and the source IP address by registering the rewriting information in the eBPF map that manages addresses, but the present disclosure is not limited thereto. The terminal device 10 may rewrite the destination IP address and the source IP address based on a method different from the eBPF program.

In the above embodiment, it has been described that the terminal device 10 sends the reset signal to the session for the application that matches the destination IP address before the rewriting, but the present disclosure is not limited thereto. The terminal device 10 may avoid the sending of the reset signal to the session for the application that matches the destination IP address before the rewriting.

In the above embodiment, it has been described that the information processing system 1 includes the internet 32 as a part of the network 30, but the present disclosure is not limited thereto. Without including the internet 32, the information processing system 1 may include only the terminal device 10, the communication lines 31 communicably connected with the terminal device 10, and the server device 20 communicably connected with the terminal device 10 through one of the communication lines 31.

In the above embodiment, it has been described that the system unit 157 that functions as the control unit 15 of the terminal device 10 operates on the user land side, but the present disclosure is not limited thereto. A major functional unit of the control unit 15 for realizing the functions of the terminal device 10 in the above embodiment, that is, the system unit 157 may operate on the kernel side. For example, in the terminal device 10, only the client application 151 may operate on the user land side.

Some embodiments of the present disclosure will be shown below as examples. However, it is noted that embodiments of the present disclosure are not limited thereto.

### Supplement 1

A terminal device that controls switching of a communication line, the terminal device comprising a control unit configured to measure a communication quality for each of a plurality of the communication lines including a main-line that is being used for communication and one or more sub-lines that are not being used for communication, and switch the communication line from the main-line to a predetermined sub-line of the one or more sub-lines, when a determination that the communication quality measured for the main-line has become lower than the communication quality measured for the predetermined sub-line is made.

### Supplement 2

The terminal device according to supplement 1, wherein the main-line and the predetermined sub-line are managed by different telecommunication carriers from each other.

### Supplement 3

The terminal device according to supplement 1 or 2, wherein the communication quality includes a quality that influences a user feeling for an application that operates in the terminal device.

### Supplement 4

The terminal device according to any one of supplements 1 to 3, wherein the control unit alters a route for policy routing, and alters an NIC that is used for a destination IP address, to an NIC for the predetermined sub-line, in the switching of the communication line.

### Supplement 5

The terminal device according to supplement 4, wherein the control unit updates a route table by issuing an update instruction about a network guidance rule.

### Supplement 6

The terminal device according to supplement 4 or 5, wherein the control unit rewrites the destination IP address and a source IP address by registering rewriting information in a map that manages addresses.

### Supplement 7

The terminal device according to supplement 6, wherein the control unit sends a reset signal to a session for an application that matches the destination IP address before the rewriting, the reset signal having a packet that includes a sequence number recorded in the map.

### Supplement 8

An information processing system comprising:
the terminal device according to any one of supplements 1 to 7;
a plurality of the communication lines that is communicably connected with the terminal device; and
a server device that is communicably connected with the terminal device through one of the communication lines.

### Supplement 9

A communication control method for controlling switching of a communication line, the communication control method comprising:
measuring a communication quality for each of a plurality of the communication lines including a main-line that is being used for communication and one or more sub-lines that are not being used for communication; and
switching the communication line from the main-line to a predetermined sub-line of the one or more sub-lines, when a determination that the communication quality measured for the main-line has become lower than the communication quality measured for the predetermined sub-line is made.

### Supplement 10

The communication control method according to supplement 9, wherein the main-line and the predetermined sub-line are managed by different telecommunication carriers from each other.

### Supplement 11

The communication control method according to supplement 9 or 10, wherein the communication quality includes a quality that influences a user feeling for an application that operates in a terminal device.

### Supplement 12

The communication control method according to any one of supplements 9 to 11, wherein the switching the communication line includes altering a route for policy routing, and altering an NIC that is used for a destination IP address, to an NIC for the predetermined sub-line.

### Supplement 13

The communication control method according to supplement 12, wherein the switching the communication line includes updating a route table by issuing an update instruction about a network guidance rule.

### Supplement 14

The communication control method according to supplement 12 or 13, wherein the switching the communication line includes rewriting the destination IP address and a source IP address by registering rewriting information in a map that manages addresses.

### Supplement 15

The communication control method according to supplement 14, further comprising sending a reset signal to a session for an application that matches the destination IP address before the rewriting, the reset signal having a packet that includes a sequence number recorded in the map.

### Supplement 16

A program that causes a terminal device to execute an operation, the terminal device controlling switching of a communication line, the operation comprising:
measuring a communication quality for each of a plurality of the communication lines including a main-line that is being used for communication and one or more sub-lines that are not being used for communication; and
switching the communication line from the main-line to a predetermined sub-line of the one or more sub-lines, when a determination that the communication quality measured for the main-line has become lower than the communication quality measured for the predetermined sub-line is made.

### Supplement 17

A vehicle that controls switching of a communication line, the vehicle comprising a control unit configured to measure a communication quality for each of a plurality of the communication lines including a main-line that is being used for communication and one or more sub-lines that are not being used for communication, and switch the communication line from the main-line to a predetermined sub-line of the one or more sub-lines, when a determination that the communication quality measured for the main-line has become lower than the communication quality measured for the predetermined sub-line is made.

### Supplement 18

The vehicle according to supplement 17, wherein the main-line and the predetermined sub-line are managed by different telecommunication carriers from each other.

### Supplement 19

The vehicle according to supplement 17 or 18, wherein the communication quality includes a quality that influences a user feeling for an application that operates in the vehicle.

### Supplement 20

The vehicle according to any one of supplements 17 to 19, wherein the control unit alters a route for policy routing, and alters an NIC that is used for a destination IP address, to an NIC for the predetermined sub-line, in the switching of the communication line.

What is claimed is:

1. A terminal device that controls switching of communication lines, the terminal device comprising a processor configured to execute:
measuring a communication quality for each of a plurality of the communication lines including a main-line that is being used for communication and one or more sub-lines that are not being used for communication; and
switching the communication line from the main-line to a predetermined sub-line of the one or more sub-lines, in a case where a determination that the communication quality measured for the main-line has become lower than the communication quality measured for the predetermined sub-line is made.

2. The terminal device according to claim 1, wherein the main-line and the predetermined sub-line are managed by different telecommunication carriers from each other.

3. The terminal device according to claim 1, wherein the communication quality includes a quality that influences a user feeling for an application that operates in the terminal device.

4. The terminal device according to claim 1, wherein the processor is configured to alter a route for policy routing, and alter an NIC that is used for a destination IP address, to an NIC for the predetermined sub-line, in the switching of the communication line.

5. The terminal device according to claim 4, wherein the processor is configured to update a route table by issuing an update instruction about a network guidance rule.

6. The terminal device according to claim 4, wherein the processor is configured to rewrite the destination IP address and a source IP address by registering rewriting information in a map that manages addresses.

7. The terminal device according to claim 6, wherein the processor is configured to send a reset signal to a session for an application that matches the destination IP address before the rewriting, the reset signal having a packet that includes a sequence number recorded in the map.

8. A communication control method for controlling switching of communication lines, the communication control method comprising:
measuring a communication quality for each of a plurality of the communication lines including a main-line that is being used for communication and one or more sub-lines that are not being used for communication; and
switching the communication line from the main-line to a predetermined sub-line of the one or more sub-lines, in a case where a determination that the communication quality measured for the main-line has become lower than the communication quality measured for the predetermined sub-line is made.

9. The communication control method according to claim 8, wherein the main-line and the predetermined sub-line are managed by different telecommunication carriers from each other.

10. The communication control method according to claim 8, wherein the communication quality includes a quality that influences a user feeling for an application that operates in a terminal device.

11. The communication control method according to claim 8, wherein the switching the communication line includes altering a route for policy routing, and altering an NIC that is used for a destination IP address, to an NIC for the predetermined sub-line.

12. The communication control method according to claim 11, wherein the switching the communication line includes updating a route table by issuing an update instruction about a network guidance rule.

13. The communication control method according to claim 11, wherein the switching the communication line includes rewriting the destination IP address and a source IP address by registering rewriting information in a map that manages addresses.

14. The communication control method according to claim 13, further comprising sending a reset signal to a session for an application that matches the destination IP address before the rewriting, the reset signal having a packet that includes a sequence number recorded in the map.

15. A vehicle that controls switching of communication lines, the vehicle comprising a processor configured to:
measure a communication quality for each of a plurality of the communication lines including a main-line that is being used for communication and one or more sub-lines that are not being used for communication; and
switch the communication line from the main-line to a predetermined sub-line of the one or more sub-lines, in a case where a determination that the communication quality measured for the main-line has become lower than the communication quality measured for the predetermined sub-line is made.

16. The vehicle according to claim 15, wherein the main-line and the predetermined sub-line are managed by different telecommunication carriers from each other.

17. The vehicle according to claim 15, wherein the communication quality includes a quality that influences a user feeling for an application that operates in the vehicle.

18. The vehicle according to claim 15, wherein the processor is configured to alter a route for policy routing, and alter an NIC that is used for a destination IP address, to an NIC for the predetermined sub-line, in the switching of the communication line.
